(19) United States
(12) Patent Application Publication
(10) Pub. No.: US 2005/0261866 A1
(43) Pub. Date: Nov. 24, 2005

(54) Thermal protection for a VLSI chip through reduced c4 usage

(75) Inventors: David William Boerstler, Round Rock, TX (US); Hiroki Kihara, Austin, TX (US); Robert Patrick Putney, Round Rock, TX (US); Daniel Lawrence Stasiak, Rochester, MN (US); Michael Fan Wang, Austin, TX (US)

Correspondence Address: Gregory W. Carr, 670 Founders Square, 900 Jackson Street, Dallas, TX, 75202, US

(73) Assignees: International Business Machines Corporation, Armonk, NY (US); Sony Computer Entertainment Inc., Tokyo (JP)

(21) Appl. No.: 10/850,401

(22) Filed: May 20, 2004

(51) Int. Cl. G06F 15/00

(52) U.S. Cl. 702/130

(57) ABSTRACT

The present invention provides for determining a temperature in a chip. A voltage across a thermal diode is generated. It is then determined whether the voltage across the first thermal diode exceeds a threshold value. The voltage is correlated with a range of values. The determination of whether the voltage across the thermal diode exceeds the threshold value is correlated with the correlation of the voltage with a range of values. Through the use of voltage level sensors, the use of C4 input/output pins are avoided.

### TECHNICAL FIELD

The invention relates generally to temperature detection and, more particularly, to temperature detection in an integrated circuit.

### BACKGROUND

Very Large Scale Integration (VLSI) chips can operate with different designs and more and more functions. This, however, creates temperature gradients within the chip. Further, chip temperatures can also vary as workloads change. It is generally important to have a way of measuring the chip operating temperature, as operating temperature can place constraints upon allowable chip performance. The measured chip temperature can then be used to modify the chip environments, such as a system fan speed or a slower chip speed, to help ensure chip temperatures remain within operation and long lifetime limits.

In conventional technologies, a linear thermal diode is used to measure the chip temperature. Generally, a linear thermal diode has a constant voltage placed upon it keeping the current constant, and measure the voltage across the thermal diode. The voltage is proportional to the temperature of the thermal diode. Hence, the chip environmental temperature can be calculated, and any necessary environmental changes can be made. However, the liner thermal diode requires two input/output (I/O) pins (C4s) that are connected to both end of the thermal diode. The voltage is measured by an external chip or other device that determines the chip temperature.

However, as VLSI chip sizes increase, chip temperature is more likely to vary across a chip. Varied workloads can also activate different sections of a chip also, so no one point on the chip is typically considered the hot spot all of the time.

With workloads and chip size issues, it is important to have more than one thermal diode for temperature measurements. However, C4 I/O pins are expensive in terms of chip “real estate”, and require the employment of a second chip or other device to measure temperature. Furthermore, routing signals from the thermal diode through the chip and then through the C4 I/Os can create undesired lengths in bus lines within the chip, which can also cause electromagnetic radiation problems, and so on. Finally, it would be useful to have the C4 pins freed for some other information transfer from the IC than to the hardware for monitoring heat statuses.

Therefore, there is a need to measure chip temperatures in a plurality of areas of an IC chip without the employment of a high number of C4 I/O pins in a manner that addresses at least some of the concerns of conventional IC temperature monitoring systems.

### SUMMARY OF THE INVENTION

The present invention provides for determining a temperature in a chip. A voltage across a thermal diode is generated. It is then determined whether the voltage across the first thermal diode exceeds a threshold value. The voltage is correlated with a range of values. The determination of whether the voltage across the thermal diode exceeds the threshold value is correlated with the correlation of the voltage with a range of values.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a prior art use of a thermal diode coupled to C4 I/O pins;

FIG. 2 depicts a level sensitive temperature sensor;

FIG. 3 depicts a plurality of temperature sensors with differing trip threshold voltages coupled to a filter; and

FIG. 4 depicts one example of the employment of both step sensors and linear sensors incorporated within a single chip.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

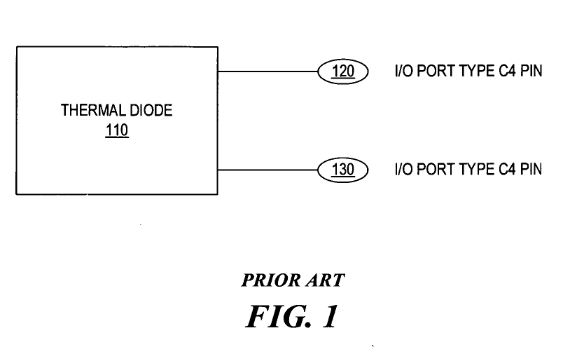

Turning now to FIG. 1, disclosed is a thermal diode 110 which is coupled to a first C4 pin 120 and a second C4 pin 130. An outside chip (not illustrated) or other device can measure the voltages on or across these pins, from which temperature measurements are then deduced. The voltages represent a continuum, which is then translated into an analog voltage level. For instance, 3.5 volts could indicate a temperature of 65.4 degrees F., 4.6 volt could indicated a temperature of 70.4 degrees F., and so on. However, the use of C4 pins uses up valuable I/O opportunities which might be more usefully employed by other devices.

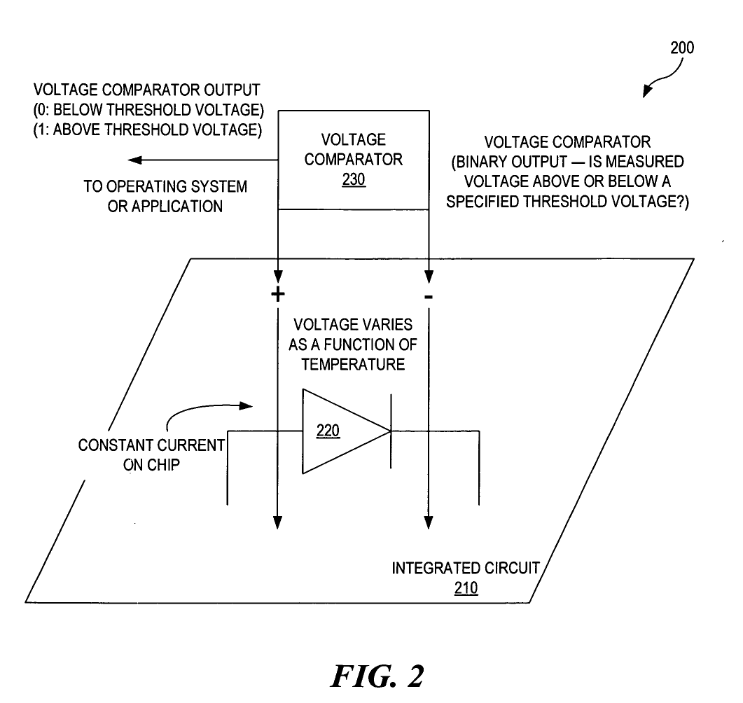

Turning now to FIG. 2, illustrated is temperature level sensor 200. The temperature level sensor 200 employs the same thermal diodes, but employs in a different way than as illustrated in FIG. 1. Instead of an analog measurement of the output of a thermal diode in order to determine the local temperature, a more simple digital two-Level logic is used within an IC circuit 210. When measuring voltage characteristics of the thermal diode 220, a value of 0 is generated by the voltage comparator 230 if the voltage generated across the thermal diode is below a predetermined threshold, and a value of 1 is generated by the voltage comparator 230 if the voltage generated across the thermal diode is above a predetermined threshold. The threshold can be set by means as understood by those of skill in the art. The voltage comparator 230 can be on the chip 210, which eliminates the need for C4 I/O connections. Furthermore, because the comparison is performed on the chip 210, rather than off the chip 210, the environmental controls can be performed by software running on or in conjunction with the chip 210, such as is the operating system, and not just always by a separate chip as in conventional system.

In the sensor 200, a substantially constant current is generated on the chip 210 across a thermal diode 220. The voltage across the thermal diode fluctuates as a function of temperature. The voltage across the thermal diode 220 is then measured by the voltage comparator 230 and compared to a specified threshold. If the voltage is below the threshold value, a value of zero is generated. If the voltage is above the threshold value, a value of one is generated. This value is then conveyed to a latch or other memory for use by software within the IC 210. The voltage comparator 230 logic is integrated within the IC chip 210.

Generally, the sensor 200 allows for the determination of whether a temperature is above or below a specified voltage value, which corresponds to a specified temperature. This information is generated and used on chip 210, so none of the valuable C4 I/O lines need to be used.

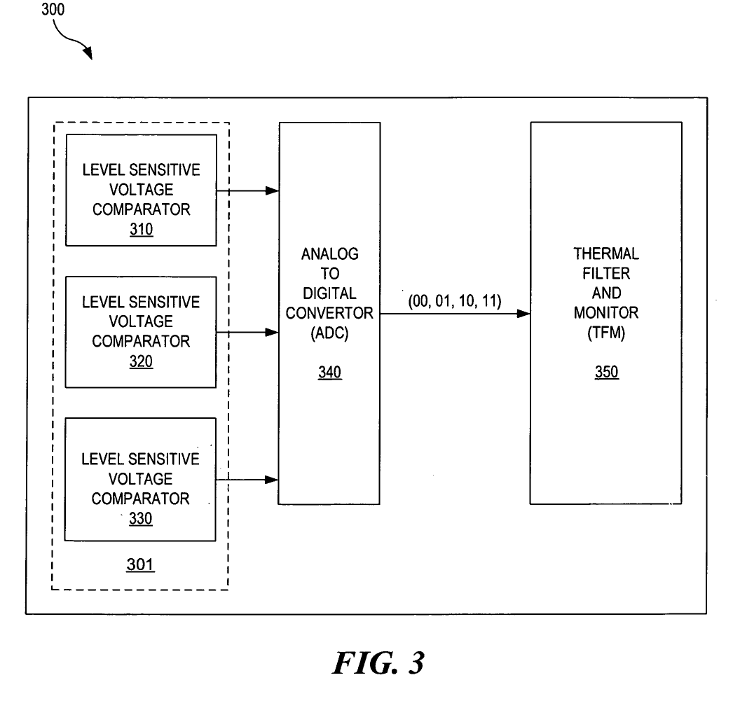

Turning now to FIG. 3, illustrated is a system 300 for determining whether a temperature is below a first threshold, between a first threshold and a second threshold, above the second threshold but below a third threshold, or above the third threshold. Each level sensitive voltage comparator 310, 320, 330 is closely spaced in a temperature sensor 301 and are coupled to a thermal diode (not shown). Each voltage comparator 310, 320 330 inputs its signal into an analog to digital converter (ADC) 340. The signals each indicate whether the voltage measured across the thermal diode is above or below a predefined threshold. Then, this signal is converted into an output signal. Each device 310, 320, 330 does this. These devices are integral to an IC chip 300.

For instance, if all three signals indicate that the voltage, and hence the temperature, is below all predetermined thresholds, the output signal could be turned into 00 and output by the ADC 340. If the first voltage threshold T1 is met, but not the second T2, then a signal 01 could be output by the ADC 340. If the second threshold T2 is also met, but not T3, then a value of 10 could be generated by the analog to digital converter. Finally, a 11 indicates that the third threshold T3 has been met or exceeded.

These values (00, 01, 10, or 11) are then input into a thermal filter and monitor (TFM) 350. The TFM 350 then filters the signals for spikes, such as might occur from a temporarily faulty reading. The TFM 350 also stores this information, and makes decisions as to what actions to perform within the IC chip to alter or control the temperature, or what actions to command the operating system to perform.

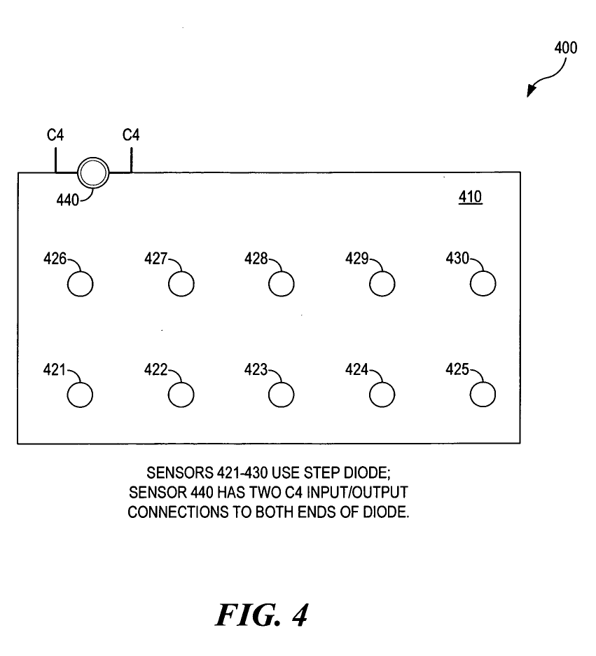

Turning now to FIG. 4, illustrated is one embodiment of a system 400 of the use of both level sensors 200 and linear sensors 100. An IC chip 410 has level sensors 421-430 integrated within. The sensors 421-430 send information denoting whether voltage, and hence temperature, thresholds have been reached, as discussed regarding the system 300. This information is then passed to a software code that determines the temperature of different parts of the chip. In a further embodiment, there is also a linear thermal diode voltage sensor 440, which has 2 C4 I/O ports. The level sensors 421-430 generally correspond to the temperature sensor 301. There is also a linear sensor 440.

In this embodiment, different temperature levels can be measured by the different kinds of sensors and correlated with one another. For instance, a given temperature, as measured by the linear thermal diode sensor 440, can denote different temperature threshold levels for different level sensor thermal diodes 421-430. For instance, if the temperature as measured at the linear thermal diode 440 is 70 degrees, this could be correlated with historical measurement data to mean that sensors 421-425 have passed the first threshold, but not the second or the third, and that sensors 426-430 have not passed the first, second or third threshold. However, if the temperature as measured at the linear thermal diode 440 is 74 degrees, this could be correlated with historical measurement data to mean that sensors 421-425 have passed the second threshold, but not the third, and that sensors 426-430 have only passed the first threshold, and so on. This data could be valuable to create a statistical model of chip behavior based upon a minimum number of linear thermal diode measurement systems.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. An system for measuring temperature by a level-sensitive thermal sensor in an integrated circuit, comprising:
a thermal diode; and
a voltage comparator configured to output indicia as a function of whether a voltage across the thermal diode as a function of a specified threshold value, wherein the thermal diode and the voltage comparator or both comprise part of the integrated circuit.

2. The system of claim 1, wherein the indicia is generated if the voltage is greater than the specified threshold value.

3. The system of claim 1, wherein the indicia is generated if the voltage is less than the specified threshold value.

4. The system of claim 1, wherein the voltage across the thermal diode is generated as a function of temperature.

5. The system of claim 1, further comprising a plurality of voltage comparators associated with the thermal diode, and are at least part of the integrated circuit.

6. The system of claim 7, wherein each of the plurality voltage comparators has its own distinct threshold value.

7. The system of claim 6, wherein the number of members of the plurality of voltage comparators are three.

8. The system of claim 1, wherein there are a plurality of level sensitive thermal sensors integral to the integrated circuit.

9. The system of claim 1, further comprising a linear thermal sensor integral to the integrated circuit.

10. The system of claim 9, further comprising a thermal filter and monitor configured to correlate an output of the linear thermal sensor and an output of the level sensitive thermal sensor.

11. The system of claim 10, wherein the filter and monitor are external to the integrated circuit.

12. A method of determining a temperature in a chip, comprising:
generating a voltage across a thermal diode;
determining whether the voltage across the thermal diode exceeds a threshold value;
correlating the second voltage with a range of values; and
correlating the determination of whether the voltage across the thermal diode exceeds the threshold value with the correlation of the voltage with the range of values.

13. A computer program product for determining a temperature in a chip, the computer program product having a medium with a computer program embodied thereon, the computer program comprising:
computer code for generating a voltage across a thermal diode;
computer code for determining whether the voltage across the thermal diode exceeds a threshold value;
computer code for correlating the second voltage with a range of values; and
computer code for correlating the determination of whether the voltage across the thermal diode exceeds the threshold value with the correlation of the voltage with the range of values.

14. A processor for determining a temperature in a chip, the processor including a computer program comprising:
computer code for generating a voltage across a thermal diode;
computer code for determining whether the voltage across the thermal diode exceeds a threshold value;
computer code for correlating the second voltage with a range of values; and
computer code for correlating the determination of whether the voltage across the thermal diode exceeds the threshold value with the correlation of the voltage with the range of values.
